(19) United States
(12) Patent Application Publication
(10) Pub. No.: US 2012/0095890 A1
(43) Pub. Date: Apr. 19, 2012

(54) System and Method for the Automated Distribution, Management and Service of Court-Related Documents

(76) Inventor: Thomas E. Santarlas, Wauchula, FL (US)

(21) Appl. No.: 13/029,752

(22) Filed: Feb. 17, 2011

Related U.S. Application Data
(63) Continuation-in-part of application No. 13/016,013, filed on Jan. 28, 2011, now abandoned.
Application No. 13/016,013 is a continuation-in-part of application No. 12/906,099, filed on Oct. 17, 2010.
Application No. 12/906,099 is a continuation-in-part of application No. 12/905,702, filed on Oct. 15, 2010, now abandoned.

(51) Int. Cl. G06Q 50/00; G06Q 30/00

(52) U.S. Cl. 705/34; 705/311

(57) ABSTRACT

Disclosed is a system and method for managing, distributing, and serving court-related documents. The system is operated by a host and utilized by a number of different entities that are involved in effecting service of court-related documents such as summonses, subpoenas, complaints, petitions and warrants. By way of the system, these court-related documents can be electronically distributed and ultimately served in an efficient manner. The system also permits the automated invoicing and billing for service related activities. The archiving of data related to effecting service can also be carried out by the present system. In still yet another embodiment, the system can automatically send emails including a status of service report, an affidavit of service and/or a proof of service as an attachment.

### CROSS REFERENCE TO RELATED APPLICATION

This applications claims priority to and is a continuation-in-part of U.S. patent application Ser. No. 13/016,013 filed on Jan. 28, 2011 and entitled “System and Method for the Automated Distribution, Management and Service of Court-Related Documents”, which claims priority to and is a continuation-in-part of U.S. patent application Ser. No. 12/906,099 filed on Oct. 17, 2010 and entitled “System and Method for the Automated Distribution, Management and Service of Court-Related Documents”, which claims priority to and is a continuation-in-part of U.S. patent application Ser. No. 12/905,702 filed on Oct. 15, 2010 and entitled “System and Method for the Automated Distribution, Management and Service of Court-Related Documents.” The contents of these applications are fully incorporated herein for all purposes.

### BACKGROUND OF THE INVENTION

1. Field of the Invention

This invention relates to an automated system for the service of court-related documents. More particularly, the present invention relates to a system for electronically distributing, managing and serving court-related documents.

2. Description of the Background Art

Serving documents such as summonses, complaints, subpoenas, petitions, and warrants upon third parties can be both time consuming and complicated for legal professionals. Effecting service of process has traditionally involved first generating the necessary documents to be served. This requires a detailed knowledge of the rules and regulations in the jurisdiction where the documents are to be served. Often times the legal professional must conduct research to discover these rules and regulations.

Depending upon the nature of the service, the legal professional may also have to get the court in the applicable jurisdiction to certify the documents or issue a summons. This, in turn, requires the legal professional to correspond with the clerk of court, often times via local counsel. Once the documents have been certified, the legal professional must find an individual to hand deliver the documents upon the third party. Finding a reliable process server may be a hit or miss proposition, insomuch as the legal professional may have little familiarity with the jurisdiction in which service is to be effected.

Despite recent advances in computer technology and electronic communications, many of the steps outlined above have remained unchanged. Thus, there exists a need in the legal field for a means of easily and efficiently carrying out service of process. There also exists a need in the field for a system whereby court-related documents can be electronically distributed, managed and, ultimately, served. There is likewise a need for a system for efficiently invoicing for tasks carried out by a process server. Finally, there exists a need for archiving all data associated with effecting service. The system and method of the present invention is aimed at meeting these and other needs.

### SUMMARY OF THE INVENTION

It is therefore one of the objectives of this invention to provide a system for the automated service of court-related documents.

It is also an object of this invention to provide a system for electronically distributing and managing court-related documents prior to being served.

Still another object of this invention is to automate the invoicing associated with tasks carried out by a process server.

A further object of this invention is to enable all data associated with effecting service to be archived for later retrieval.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart illustrating the system of the present invention.

FIG. 2 is a flow chart illustrating the automated invoicing feature of the present invention.

FIG. 3 is flow chart illustrating the archiving feature of the present invention.

FIG. 4 is a screen shot of a program carrying out the system of the present invention.

FIG. 5 is a screen shot of a program carrying out the archiving feature of the present invention.

FIG. 6 is a flow chart illustrating the automatic e-mail notification system of the present invention.

Similar reference characters refer to similar parts throughout the several views of the drawings.

### DETAILED DESCRIPTION OF THE PREFERRED EMBODIMENT

The present invention relates to a system and method for managing, distributing, and serving court-related documents. The system is operated by a host and utilized by a number of different entities that are involved in effecting service of court-related documents such as subpoenas, summonses, complaints, petitions, and warrants. By way of the system, these court-related documents can be electronically distributed and ultimately served in an efficient manner. The system also permits the automated invoicing and billing for service related activities. The archiving of data and/or files related to effecting service can also be carried out by the present system. The details of the present invention are more fully explained hereinafter.

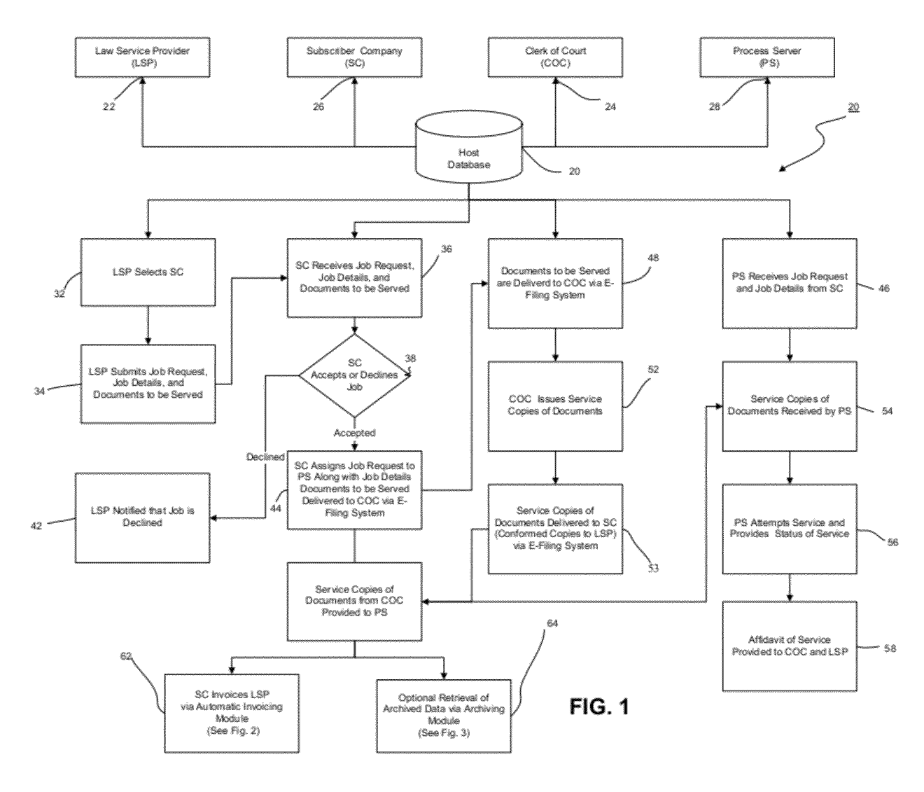

FIG. 1 is a flow chart illustrating the system 20 of the present invention as well as the various entities utilizing the system. These entities include law service providers (LSP) 22, which may include, for example, attorneys, law firms, paralegals, legal secretaries, and/or any other individuals or entities that generate, or assist in creating court-related documents. For purposes of this application, LSP's include, but are not limited to, any client of the subscriber companies described below. Although these clients will often be attorneys or law firms, the LSP definition specifically includes non-law firm corporations, non-attorney individuals, other corporate entities, or individuals representing themselves in a pro-se capacity. Other entities utilizing the system include clerks of court (COC) 24, which broadly includes any government-authorized individuals or entities that are involved in certifying court-related documents or in issuing summonses, or other related documents. For instance, COCs may be involved in providing a summons associated with a complaint or in certifying subpoenas or warrants.

The system may also be used by subscriber companies and process servers. Subscriber companies (SC) 26 are service providers that are involved in the service of court-related documents. This may be, for example, a company that oversees and manages a number of different process servers, either as employees or independent contractors. Finally, the process server (PS) 28 is the individual, or individuals, who are involved in actually effecting service of process. A PS may work as an employee or independent contractor for a particular SC. Alternatively, in some instances, the SC and the PS may be one and the same. Namely, SCs are defined herein as including a PS operating individually.

With continuing reference to FIG. 1, it is seen that the entire system is carried out over a computer network, such as the Internet. Alternatively, the network may comprise a Local Area Network, a Wireless Local Area Network, a Wide Area Network, or a Metropolitan Area Network. The system is also carried out over existing Internet-based, court-sponsored e-filing systems. An example of such a system is the CM/ECF e-filing system currently in place by the U.S. Federal Court System.

In accordance with the step 32 of the system, the LSP selects a particular SC. The LSP then submits a job request, job details, and documents to be served at step 34. At step 36, the SC receives the job request, job details, and court-related documents from the LSP over the network. The job request lists the general details of what the LSP is attempting to accomplish. The job request can be, for example, a request to serve a summons and complaint, or serve a subpoena or warrant. The job details provide further specifics regarding the individual or entity to be served, any applicable deadlines for service, as well as the geographic location for effecting service. Finally, the SC would receive copies of the court-related documents to be served from the LSP via the network. Again, these court-related documents may be a summons, complaint, subpoena, or a warrant. However, those knowledgeable in the legal industry will realize that there are additional court-related documents that have not been specified that could be employed in conjunction with the present invention.

In the next step 38, the SC, after reviewing the job details and the court-related documents, can either elect to accept or decline the job. The job may be declined, for instance, if the SC cannot meet the applicable deadline or if the job details specify a geographic area in which the SC does not operate. The LSP is then notified via the network whether the SC has declined or accepted the job request. In the event that the job is declined, as at step 42, the LSP can select another SC and begin the process anew.

Alternatively, if the SC accepts the job, the SC thereafter assigns the accepted job to a particular PS at step 44. It is envisioned that, in accordance with this system, the SC would maintain a database of numerous PS' in various geographic areas. Thus, the SC would select the most suitable PS and assign him or her the job request. Additionally, as explained below, the SC would also submit the court-related documents to the COC via the court sponsored e-filing system at step 48. The LSP may alternatively provide the court-related document to the COC, if such a submission is required by the court. Once issued, the service copies of the court-related documents would be provided to the SC with a conformed copy to the LSP. The SC then provides the PS with the job request, job details and service copies of the court-related documents at step 46.

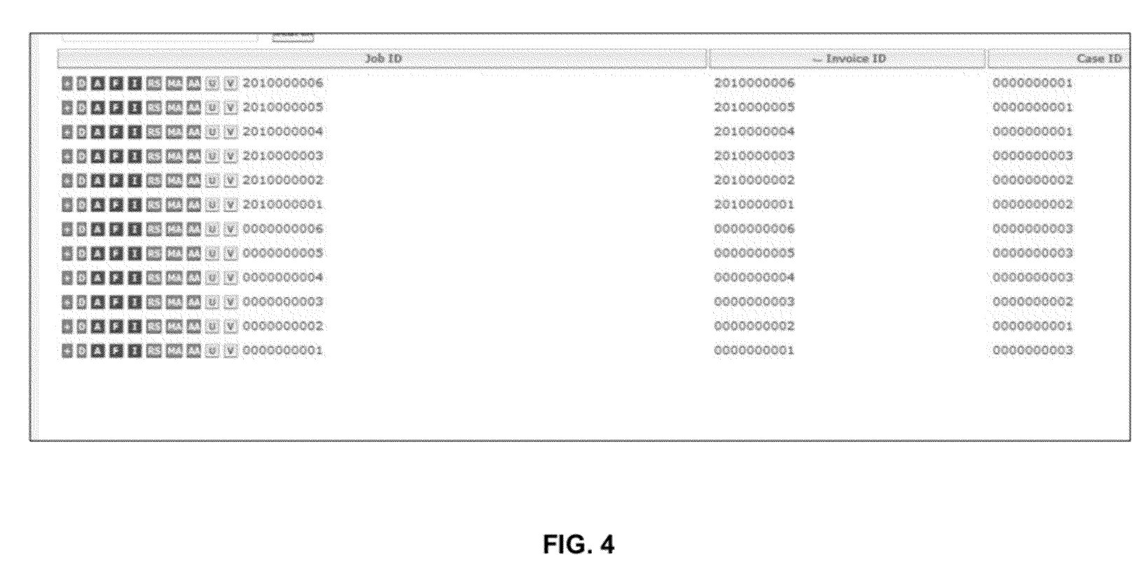

The database maintained by the SC would likewise contain a listing of all accepted jobs, the PS to which the job has been assigned, as well as all job-related details and court-related documents. FIG. 4 is a screen shot illustrating the possible graphical organization of such information within the database. As illustrated, a particular job would be referenced by Job ID, Invoice ID, and Case ID. Hyperlinks would likewise be provided to permit the SC to access any documents associated with a job. These documents may include, for example, invoices to the LSP, requests for service, affidavits of service, field sheets from the PS detailing service attempts, the payment history of the LSP, and/or uploaded attachments. This interface allows the SC to organize and keep track of a number of different jobs over time.

Turning back to FIG. 1, prior to attempting service of the court-related documents, the SC would deliver the documents to the COC at step 48. It is envisioned that this would most likely be carried out by way of the court-sponsored e-filing system. Namely, the documents to be served would be provided to the COC via the e-filing system. The COC would thereafter issue service copies of the documents in a conventional fashion at step 52. The COC would then provide service copies of the court-related documents to the SC. Conformed copies would also be provided to the LSP (note step 53). The SC, in turn, provides the service copies of the court-related documents to the PS for service of process. In an alternative embodiment, the individual PS could directly retrieve the service copies of the documents via the e-filing system at step 54.

With the service copies of the documents in hand, the PS would then attempt service upon the third party in accordance with traditional methods at step 56. The PS can provide electronic status updates regarding the attempts to serve the documents. This could be accomplished by the PS logging into the SC program/database via personalized login credentials and manually inputting the service and/or attempt history data. In addition the status updates could also be provided to the SC for input. Regardless, the data once entered will be available to the LSP via the network.

Finally, once service is effected, the PS would generate an affidavit of service at step 58. This affidavit can be electronically signed by the PS. Such an affidavit could be delivered directly to the LSP via the network. The signed affidavit can also be electronically sent to the COC for filing. It is also envisioned that the SC would obtain a copy of the affidavit of service for storage in the host database.

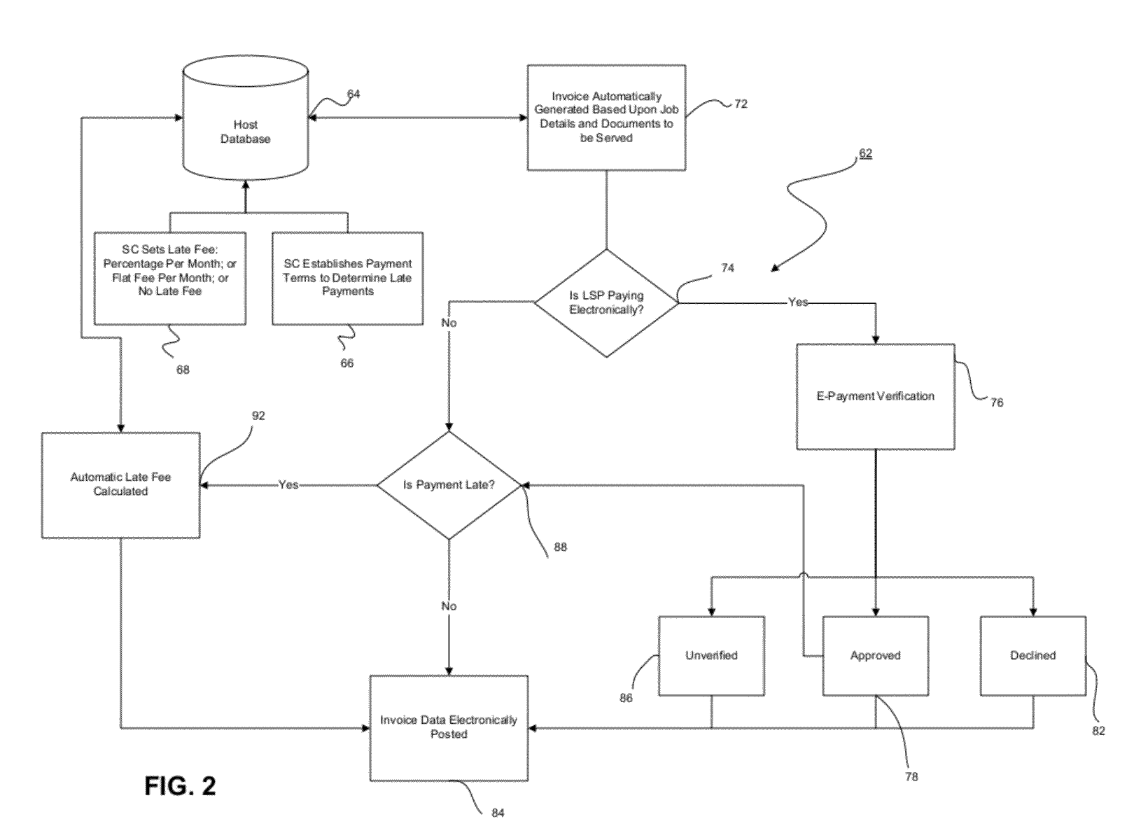

FIG. 1 also illustrates two additional modules that can be used with the system. These include an invoicing module 62 and an archiving module 64. These modules are described next in conjunction with FIGS. 2 and 4.

### Invoicing Module

The invoicing module 62 automatically invoices an LSP and processes any invoice payments. With reference to FIG. 2, it is shown that the module utilizes a database 64, which contains payment terms that are previously established by the SC at steps 66 and 68. These payment terms may include the amounts to be charged for various jobs. These amounts would be based, in part, on the job details and the court-related documents to be served. The payment terms stored in the database further include when the invoice is payable and the applicable late fee. The module thereafter automatically generates an invoice to an LSP at step 72 on the basis of an accepted job. Again, the invoice is automatically generated in accordance with the established payment terms stored in database 64.

Thereafter, the module automatically determines whether the LSP is providing an electronic payment over the network at step 74. If such an electronic payment is being made, the SC verifies the payment at step 76. Namely, the SC either approves the payment at step 78 or declines the payment at step 82. The approval or lack of approval is reflected by an electronically updated invoice at step 84. Likewise, if the e-payment has neither been approved nor declined but is rather unverified, such as at step 86, this information, too, is electronically posted to the invoice at step 84.

Thereafter, whether the LSP is paying electronically or otherwise, the module automatically determines whether the invoice payment is late at step 88. This determination is made with reference to the established payment terms stored in the database. If the determination is made that the payment is late, an automatic late fee is computed by the module at step 92, with the late fee being computed in accordance with the established payment terms. Finally, the LSP is provided an updated invoice at step 84 which can be either electronically delivered to the LSP or posted to the database to be accessed by the LSP at a later time. This electronic invoice is updated to reflect approved or declined electronic payments, the delinquent status, and the applicable late fees.

### Archiving Module

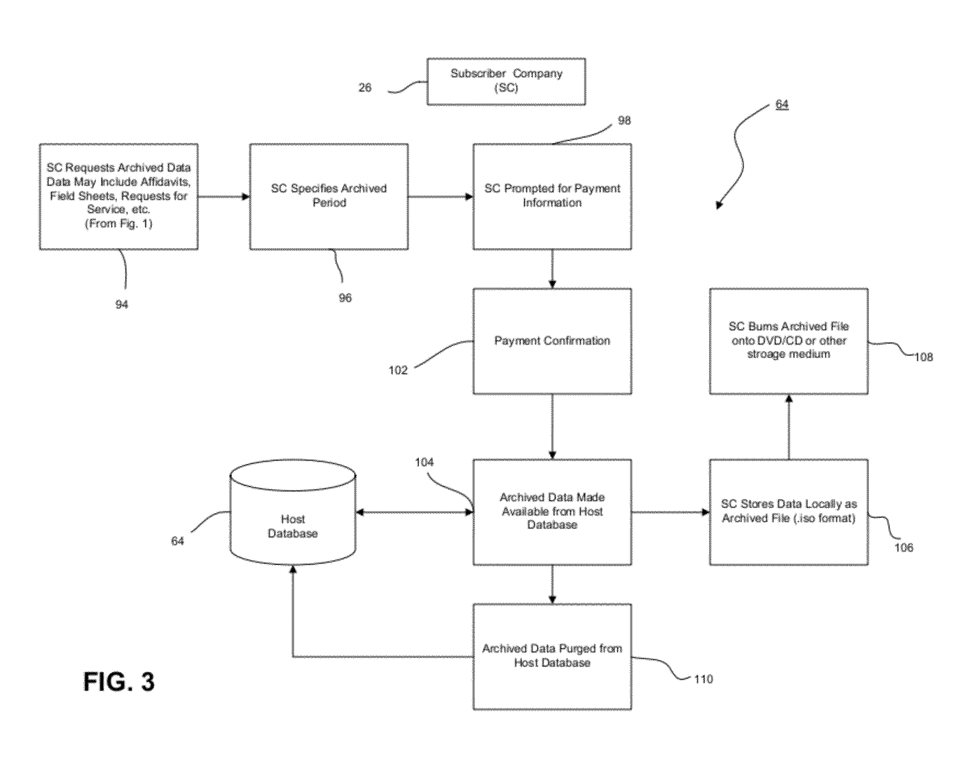

With reference to FIG. 3, the archiving module permits the SC to access and store archived data relating to prior job requests. The historical data to be archived may include, but is not limited to, job details, court-related documents, field sheets, affidavits of service, requests for service, uploaded attachments, and invoicing and payment information. The uploaded attachments can include any type of file, such as pictures, videos, website, or sound files. This archived data is initially stored in a host database.

The archiving module accepts a request for archived data from the SC at step 94. Thereafter, the SC is prompted to specify an archived period at step 96. This archived period may be, for example, a week, a month, quarterly, semi-annually, annually or multiple years. The SC is prompted for payment at step 98 before gaining access to the archived data. The amount of payment required depends, in part, upon the length of the archive period specified. This payment is larger for larger archived periods and is smaller for smaller archived periods. Likewise, the payment may also depend, in part, upon the total volume of archived data requested.

In the next step 102, the SC provides an electronic payment. This payment is made directly to the system host. Once payment is confirmed, at step 104, the SC is permitted to access to download the archived data. Thereafter, the SC is permitted to store the downloaded data locally at step 106. This can be done by either storing the archived data on a hard drive, a flash drive, a CD, or a DVD, or on any other type of storage medium (note step 108). It is envisioned that the archived data would be stored in an archived .ISO file format and then burned and saved by the SC to a CD or a DVD, or on any other type of storage medium such as a hard drive and/or a flash drive. Finally, once the data is downloaded from the host database, it can be erased by the host to conserve storage capacity at step 110.

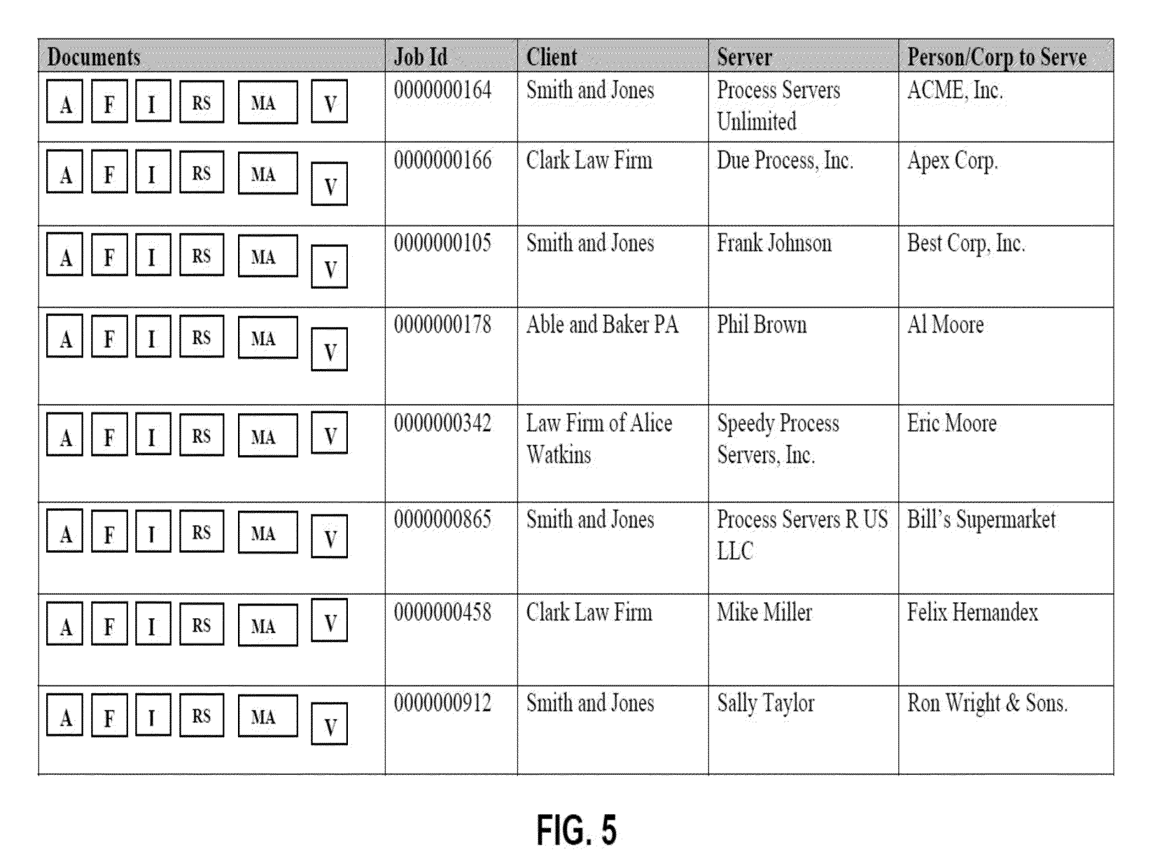

FIG. 5 is a screen shot from a program running the archiving module. This allows the SC to easily see and access all archived data. The screen includes columns for “Job ID”, “Client”, “Server”, and “Person/Corporation to be Served.” Also included are hypertext links to all archived documents. These documents may include, but are not limited to, Affidavits of Service “A,” Field Sheets “F,” Invoices “I,” Requests for Service “RS,” and Mailing Affidavits “MA.” Other attachments, which can be in any of a variety of formats, can be downloaded and stored via the archiving module as well. By clicking on the view “V,” link the user is presented with a listing of all uploaded attachments. Thereafter, by clicking on an individual item in the list, the uploaded attachment can be viewed. The information on the screen can also be sorted by clicking on an individual column heading. For example, clicking on the “Job ID” column, the jobs are arranged in numerical order of the Job ID. Searching can also be carried out via a quick search feature. This allows searching of documents, Job IDs, Clients, Servers or Persons/Corps. to be served. Moreover, as letters are typed into the quick search field, irrelevant data will be removed from the screen.

### E-Mail Notification Module

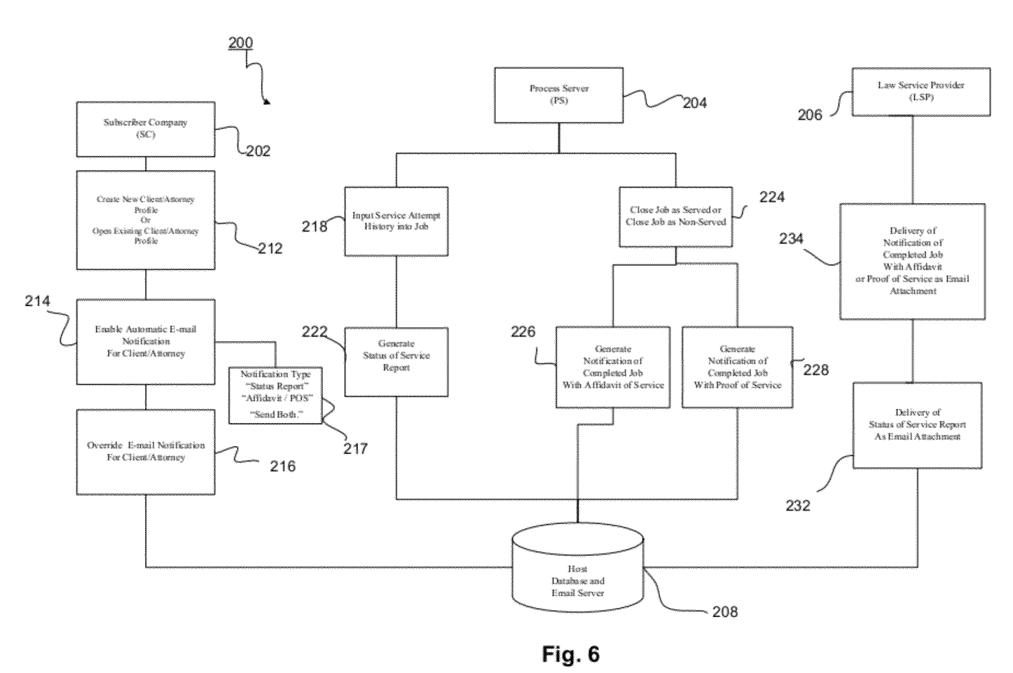

The automatic email notification system 200 is disclosed in connection with FIG. 6. The system 200 includes a subscriber company (SC) 202, a process server (PS) 204, and a law service provider (LSP) 206, all of which are interconnected via an email server 208. The SC 202, PS 204, and LSP 206 are as described above in connection with the primary embodiment. The SC 202, PS 204, and LSP 206 all interact with a host database, which in this embodiment includes the email server 208.

The system 200 permits the SC 202 to send automatic email notifications. Specifically, at step 212 the SC 202 creates a new client/attorney profile or calls up an existing client/attorney profile. As part of each profile, at step 214, the SC 202 can enable the client/attorney to receive an automatic email notification. This can be achieved via a check-mark box or radio button. The automatic emails will thereafter be delivered to the email address on file for the particular LSP 206.

Each job includes an associated job profile menu. This menu includes all relevant information for a particular job or service. This includes, but is not limited to, PS name, client name, attorney name, paralegal name, case caption, priority of service, PS instructions, name of person or corporation to serve, address, etc. A paralegal drop-down menu is accessible from this job profile menu. The SC can also tailor the specific E-mail notifications to be delivered to a LSP. In the profile menu, the SC will be presented with an Automatic E-mail Notification box 217. Clicking on this box will present the SC with the following choices: “Status Report”, “Affidavit/POS”, or “Send Both.” This functionality allows the SC to decide the type of automatic e-mail notification report that will subsequently be transmitted to the LSP client. Depending upon the option selected, the following E-mail notifications are available:
Activating the “Status Report” button will enable status reports to be automatically e-mailed to the LSP.
Activating the “Affidavit/POS” button will enable Affidavit's or POS's to be automatically e-mailed to the LSP.
Activating the “Send Both” button will enable Status Reports and Affidavit's/POS's to be automatically e-mailed to the LSP.

The paralegal drop-down menu includes an override email check-mark box (or radio button). At step 216, this override can be activated so that any automatic email notification, as well as any manually sent emails, will be diverted to the paralegal assigned to a particular job. Namely, any emails sent by the system will be delivered to the email address (or addresses) listed inside the associated paralegal profile. If the box is unchecked, this functionality is deactivated and all emails will go to the email address located in the contact section of the attorney/client profile. This override feature is available on a job-by-by basis and is not a master override.

In accordance with the system, a PS 204 can input service attempts into a particular job ticket at step 218. This will include, for examples, details regarding efforts to effect service on an individual or corporation. Thereafter, a status of service report is automatically generated at step 222. This report is preferably generated as an attachment to an email that is automatically sent via email server 208 to an LSP 206. The email can be automatically sent immediately after the report is generated. The PS 204 can also indicate, at step 224, that a job has been closed due to service being complete or the individual/corporation not being served. Depending upon the particular jurisdiction and court, completion of service can be evidenced by either an affidavit of service or proof of service. At step 226, an affidavit of service is automatically generated as an email attachment. At step 228, a proof of service is automatically generated as an email attachment. In either instance, the email is then automatically sent to the particular LSP 206 associated with the account via email server 208.

In each of the above examples, the report is sent as an email attachment. It is also preferred that the job number associated with the particular project appear in the subject line of the email. The from address can be a “no-reply” format to indicate that it should not be replied to. Other email formatting can also readily be used. For instance, textual emails and/or HTLM formatting can be used in lieu of an email attachment.

Any notifications generated by the PS 204 will be sent to the appropriate LSP 206 via email server 208. The emails will be delivered pursuant to the profile established by the SC 202. This profile can be stored in host database 208. At step 232, the LSP 206 receives the status of service report as an email attachment. The proof of service (e.g. evidencing documents served or not served) or affidavit of service (e.g. evidencing documents served or not served) are received as email attachments at step 234.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system for managing, distributing, and serving court-related documents, the system being utilized by a number of different entities, including subscriber companies (SC), law service providers (LSP), clerks of court (COC), and process servers (PS), with each of the entities communicating over a computer network and a court sponsored e-filing system, the system comprising the following steps:
the SC receiving a job request, job details, and court-related documents from an LSP over the network;
the SC either accepting or declining the job request based upon the job details and the court-related documents;
notifying the LSP via the network whether the SC has declined or accepted the job request;
providing a database accessible by the SC, the database graphically listing all accepted jobs, the assigned PS, the job details, the court-related documents, and any uploaded attachments;
the SC delivering the court-related documents for an accepted job to the COC via the court sponsored e-filing system, the COC issuing service copies of the court-related documents;
the SC assigning an accepted job request to a particular PS and delivering the job request, job details, and service copies of the court-related documents to the assigned PS via the network;
the PS retrieving the service copies of the court-related documents from the SC via the network;
the PS attempting to serve the service copies of the court-related documents and providing status updates regarding the attempts to the LSP via the network;
after completing the service of the court-related documents, the PS generating an affidavit of service and affixing his/her electronic signature;
automatically sending an email to the LSP with the affidavit of service or proof of service included as an attachment, the affidavit of service and the proof of service can evidence the service or non-service of legal documents.

2. The system as described in claim 1 wherein a status of serve report can also be automatically sent via email.

3. The system as described in claim 1 further comprising an automated invoicing module for automatically invoicing an LSP and processing invoice payments from an LSP, the invoicing module carrying out the following steps:
providing a database of payment terms established by the SC, the payment terms including amounts to be charged on the basis of job details and the court-related documents, the payment terms further including when the invoice is payable and the applicable late fee;
generating an invoice for an LSP on the basis of an accepted job, the invoice being automatically generated in accordance with the established payment terms;
determining whether the LSP providing an electronic payment and permitting the SC to either approve or decline the electronic payment;
determining whether the invoice payment from the LSP is late by referencing the established payment terms;
automatically computing the late fee in the event the invoice payment is late, the late fee being computed with reference to the established payment terms;
electronically delivering an updated invoice to the LSP, the updated invoice reflecting approved or declined electronic payments, and applicable late fees.

4. The system as described in claim 1 further comprising an archiving module for permitting a SC to access and store archived data relating to job requests, the historical data including job details, court-related documents, field sheets, affidavits of service, requests for service, uploaded attachments, and invoicing and payment information, the archived data initially being stored in a host database, the archiving module carrying out the following steps:
accepting a request for archived data from a SC and prompting the SC to provide an archived period;
prompting the SC for payment, the payment being determined, in part, on the basis of the archived period;
accepting and confirming payment from the SC;
permitting the SC to download the archived data once payment is accepted and confirmed;
permitting the SC to access and store the downloaded data locally in an archived file format;
erasing the downloaded data from the host database after it has been accessed by the SC.

5. A system for managing, distributing, and serving court-related documents, the system being utilized by a number of different entities, including subscriber companies (SC), law service providers (LSP), clerks of court (COC), and process servers (PS), with each of the entities communicating over a computer network, the system comprising the following steps:
the SC receiving a job request and court-related documents from an LSP over the network;
the SC assigning an accepted job request to a particular PS and delivering the job request to the assigned PS via the network;
the SC delivering the court-related documents to the COC, the COC issuing service copies of the court-related documents;
the PS retrieving the service copies of the court-related documents via the network;
the PS attempting to serve the service copies of the court-related documents and providing status updates regarding the attempts;
automatically sending an email to the LSP with the status updates included as an attachment.

6. The system as described in claim 5 further comprising an automated invoicing module for automatically invoicing an LSP and processing invoice payments from an LSP, the invoicing module carrying out the following steps:
providing a database of payment terms established by the SC, the payment terms including when the invoice is payable and the applicable late fee;
generating an invoice for an LSP on the basis of an accepted job;
determining whether the invoice payment from the LSP is late by referencing the established payment terms;
automatically computing the late fee in the event the invoice payment is late, the late fee being computed with reference to the established payment terms;
electronically delivering an updated invoice to the LSP, the updated invoice reflecting approved or declined electronic payments, and applicable late fees.

7. The system as described in claim 5 further comprising an archiving module for permitting a SC to access and store archived data relating to job requests, the historical data including job details, court-related documents, field sheets, affidavits of service, requests for service, and invoicing and payment information, the archived data initially being stored in a host database, the archiving module carrying out the following steps:
accepting a request for archived data from a SC and prompting the SC to provide an archived period;
permitting the SC to download the archived data;
permitting the SC to access and store the downloaded data locally in an archived file format;
erasing the downloaded data from the host database after it has been accessed by the SC.
